(19) United States
(12) Patent Application Publication
(10) Pub. No.: US 2022/0083025 A1
(43) Pub. Date: Mar. 17, 2022

(54) METHOD FOR CONFIGURING A DRIVE SYSTEM FOR A TECHNICAL DEVICE

(71) Applicant: LENZE SE, Aerzen (DE)

(72) Inventors: Jan Bruening, Wenningsen (Deister) (DE); Ulf Truschkat, Hameln (DE); Robert Wloch, Doerentrup (DE); Raimund Kuetemeier, Porta Westfalica (DE); Jasper Pille, Aerzen (DE); Sven Peter, Bremen (DE); Olaf Goetz, Brakel (DE)

(73) Assignee: LENZE SE, Aerzen (DE)

(21) Appl. No.: 17/289,110

(22) PCT Filed: Oct. 29, 2019
(86) PCT No.: PCT/EP2019/079551

§ 371 Date: Nov. 30, 2021

(30) Foreign Application Priority Data
Oct. 29, 2018 (DE) 10 2018 126 995.1

(51) Int. Cl. G05B 19/414

(52) U.S. Cl. CPC G05B 19/414; G05B 2219/31103

(57) ABSTRACT

The invention relates to a method for configuring a drive system for a technical device, wherein: the technical device consists of at least one module; the drive system is composed of a plurality of components; the components of the drive system are selected from a large number of possible component types; each selectable component type is allocated a component type data object in a data storage device, said component type data object containing component type data about the properties, more particularly the technical properties, of the component type. In a data storage device, module type data objects are stored that are allocated to module types, wherein the module type data objects contain module type data about the properties, more particularly the technical properties, of the module types. First, the module type of the at least one module which makes up the technical device is selected by a user via a user interface, and then a module data object allocated to the module is generated by means of a data processing device, said module data object containing module data about the properties, more particularly the technical properties, of the module type of the at least one module, and, on the basis of the module data, the component type of at least one component of the drive system is selected.

### TECHNICAL FIELD

The invention relates to a method for configuring a drive system for a technical device and to a configuration system and to a computer program product.

### BACKGROUND OF THE INVENTION

Technical devices, for example complex machines, production lines, robotic arms or the like, usually require drive systems which effect the movements of the technical device which are required for the function. In this case, the drive systems in turn comprise a plurality of components, such as control devices, motors and/or transmissions. In addition, a component of such a drive system may be a software component which is executed by the control device during operation of the technical device.

These components are often selected from the product ranges of the respective manufacturers. These product ranges comprise a multiplicity of different component types. A component type should therefore be understood as meaning a particular, identifiable configuration of a component of a drive system, for example a motor in a clearly defined embodiment. Therefore, each component can be assigned precisely one particular component type, whereas a plurality of identical components are assigned to the same component type.

One of the tasks when developing a technical device therefore involves selecting the components of the drive system for the technical device from a multiplicity of available component types. This is usually possible only when the technical requirements imposed on the individual components of the drive system of the technical device are already known. This results in the components being selected from the available component types only at a very late stage in the process of developing the technical device. In addition, this selection process is associated with a large amount of time and work to be provided by comparatively highly qualified persons.

It would therefore be desirable to automate the process of selecting the components.

### SUMMARY OF THE INVENTION

Methods in which suitable components are selected with the aid of a data processing device have therefore already been developed. The required components of a drive system, for example of a motor and of a transmission, are selected by virtue of these components being specified by means of component data assigned to the respective components. These data may be, for example, the required power and the required torque of the motor as well as the required ratio of the transmission. Component type data objects stored in a data storage device are now searched with the aid of a search algorithm.

In this context, a component type data object should be understood as meaning a data object which contains data relating to a particular component type to which the component type data object is assigned. These data are referred to as “component type data” below. The component type data may be, for example, the rotational speeds and torques of a motor type or the ratio of a transmission type. In such methods, the data processing device compares the component data relating to the required components with the component type data relating to the component types which are available, for example, in the product range of a manufacturer of components of drive systems. The data processing device can now select the component types for the required components on the basis of this comparison.

Although this dispenses with manually searching catalogs, the fundamental problem of the components of the drive system being able to be selected only at a late stage in development still exists.

Therefore, the system described herein is a method, a system and a computer program product which make it possible to select the components of the drive system of the technical device at an early stage in the planning of a technical device with the lowest possible use of manpower.

### DESCRIPTION OF VARIOUS EMBODIMENTS

In order to carry out the method, the technical device is first of all described by means of at least one module. A module is a technical device or a part of a technical device that can be differentiated in terms of its task within a more complex technical device.

For example, a lathe may be a technical device which comprises a “lathe” module. However, a packaging machine, for example, which comprises a plurality of modules, can also be considered to be a technical device. One of the modules may be a conveyor belt which conveys the goods to the packaging machine. A further module may be a supply device for packaging material. A further module may be a robotic arm which packages the goods. A further module may be a further conveyor belt for transporting away packaged goods. Such a technical device would then comprise four modules in this consideration.

Module type data objects are stored in a data storage device. The module type data objects are assigned to particular module types. The module types may be, for example, the “conveyor belt” module type, the “robotic arm” module type and/or the “supply device” module type. The module type data objects contain module type data relating to the properties of the module types. These are, in particular, technical properties, for example the number of drive axles. Design features are stored here, in particular.

The user now selects the module type of the at least one module via the user interface. According to the above examples, the user can select the “lathe” module type, for example. However, the user could likewise select a plurality of modules for a more complex technical device. With respect to the packaging machine, the user would select, for example, two modules of the “conveyor belt” type, one module of the “supply device” type and one module of the “robotic arm” type. It goes without saying that, within the scope of the method, the user can also be guided by the system or the computer program product in a multi-stage selection method for selecting the corresponding module. For example, related module types can be combined to form groups, wherein a module type group is first of all selected. For example, the user can select the “robotic arms” module type group and can then choose between robotic arms having a different number of axes, for example.

The data processing device can now generate a module data object assigned to the module. This module data object contains module data. Immediately after generating the module data object, which is carried out on the basis of the module data type object assigned to the selected module type, the module data relate to the properties of the module type associated with the respective module.

The module data and/or the module type data may relate to at least one module-type-specific performance feature, in particular wherein the performance feature is selected from:
a performance indication which relates to the performance of the module when performing its specific intended function, in particular a performance indication relating to a conveying capacity and/or a production capacity,
a compatibility indication which relates to the compatibility of the module with another module and/or a component,
an indication of the number and/or respective function of the driven axles.

The performance indication which relates to the performance of the module when performing its specific intended function may be, for example:
A minimum value of a mass of an object which is intended to be moved by the module. This may be, for example, the mass of an object which is intended to be transported on a conveyor belt, or the mass of an object which is intended to be moved by means of a pick-and-place device.
A minimum value of an acceleration and/or of a speed of an object which is intended to be moved by the module.
A minimum value of an acceleration and/or of a speed of an element of the module that is designed to interact with an object. The element of the module that is designed to interact with an object may be, for example, a manipulation device for moving the object, for example a gripping device. It may likewise be, for example, a tool for processing the object, for example a welding device.
The number of objects to be moved per unit time by the module.
The number of movement cycles to be carried out per unit time by an element of the module that is designed to interact with an object. This may be, for example, the number of movement cycles per unit time of a pick-and-place device, for example the number of picks per unit time.

A compatibility indication which relates to the compatibility of the module and/or module type with another module and/or a component is, in particular, a list of modules, module types, components and/or component types which are compatible with the module. The components and/or component types may be, for example, control devices and/or types of control devices which are suitable for controlling the module and/or a module of this type in such a manner that it can perform its intended task. If the module and/or the module type is, for example, a picker and/or a particular type of picker, the compatibility indication may contain a list of control devices and/or types of control devices which are suitable for pick-and-place applications.

The data processing device can now select the component type of at least one component of the drive system on the basis of the module data.

In contrast to conventional methods in which the selection is made on the basis of the component data to be determined beforehand by means of design, the data processing device now resorts to module data which already describe the technical properties of the technical device in which the drive system is intended to be used. In contrast to the component data, these module data are usually already definite at the start of the development process.

After selecting the module type of the at least one module, the user is advantageously given the opportunity to adapt and/or supplement the module data relating to the at least one module. For example, after selecting the “conveyor belt” module type, the conveying capacity and/or the conveying speed of the conveyor belt can be adapted to the requirements. The module type data relating to the “conveyor belt” module type then contain, for example, information relating to the relationship between the “conveying capacity” and “conveying speed” parameters, on the one hand, and the “required drive power” and “required rotational speed” parameters, on the other hand. These relationships stored in the module data can be used by the data processing device to carry out an automated selection of suitable component types for the components of the drive system on the basis of the module data.

Accordingly, the module type data and/or the module data may contain module-type-specific calculation principles for calculating the technical requirements imposed on the components of the drive system of the module. The module-type-specific calculation principles are, in particular, qualitative or quantitative relationships between the quantitative and qualitative requirements imposed on the functionality of the module, in particular on the performance features of the module relating to the functionality of the module, and the qualitative and quantitative requirements imposed on the performance features of the drive system that are needed to meet these requirements.

The module-type-specific calculation principles may comprise mechanical relationships between at least one axle driven by an electrical drive and an element of the module which is moved by the drive and is designed to interact with an object and/or between an axle driven by an electrical drive and an object moved by the module by means of the drive. This makes it possible to calculate quantitative requirements imposed on performance features of the component type during the selection of the at least one component type and to compare the requirements with the component type data relating to the possible component types. If the module is a conveyor belt which is intended to be able to move objects with a particular mass, at a particular speed and/or with a particular acceleration, this makes it possible, for example, to calculate which requirements are imposed on the maximum torque, the maximum rotational speed and/or the torque/rotational speed characteristic curve of an electric motor which drives an axle of the conveyor belt within the scope of selecting the at least one component type. The data calculated in this manner may be compared with module type data relating to possible types of electric motors within the scope of the selection process in order to ensure that the selected motor type or the selected motor types is/are suitable for ensuring that the conveyor belt meets the desired requirements.

The quantitative performance features and the qualitative performance features of the module should be understood as meaning, in particular, performance features which must be complied with by the module so that the module can perform its intended function. For example, in the case of the “conveyor belt” module type, the conveying capacity and/or the conveying speed can be considered to be quantitative performance features. The quantitative performance features may be, in particular, technical variables which must exceed or undershoot particular limit values. The qualitative performance features are performance features which must only be qualitatively complied with. These include, for example, a particular splash guard and/or a compatibility indication which relates to the compatibility of the module with another module and/or module type and/or a component and/or a component type.

In particular, the performance features of the module are distinguished by the fact that they are based on the module as a whole and not only on a part of the module. These performance features have the advantage that they are usually already known at a very early stage in the planning of a technical device. That is to say, the user can select the module type on the basis of the module type data relating to the performance features.

The module data and/or the module type data may contain information relating to the structural design of the module type. This information includes, in particular, data relating to the number and properties of the drive axles of the respective module type. The module type data may contain, for example, the information stating that a module has two driven axles. This results in the data processing device selecting the component types of a corresponding number of components which are required for the respective axles.

The module data and/or the module type data also contain, in particular, module-type-specific calculation principles for calculating the technical requirements imposed on the performance features of the components of the drive system.

The component data and/or the component type data may relate to at least one component-specific performance feature, in particular wherein the performance feature is selected from:
an indication relating to the intended function of the component as part of the drive system, in particular the intended function of the component with respect to a driven axle,
an indication relating to the performance of a component during its intended use, in particular an indication relating to a rotational speed, a torque and/or a power,
a compatibility indication which relates to the compatibility of the component with a module and/or another component.

The performance features of the components of the drive system may be quantitative and/or qualitative performance features of the component and/or of the component type of the drive system. A quantitative performance feature of an electric motor may be its maximum power, for example. A qualitative performance feature of a component may be, for example, the compatibility of an electric motor with a control device of a particular type.

An indication relating to the performance of a component during its intended use may be, for example, the ratio of a transmission, the processor power of a control device, a torque indication of an electric motor, in particular a maximum torque and/or a torque/rotational speed characteristic curve of an electric motor, a rotational speed indication of an electric motor, in particular a maximum rotational speed of an electric motor.

A compatibility indication which relates to the compatibility of the component with a module and/or another component is, in particular, a list of modules, module types, components and/or component types which are compatible with the component. The components and/or component types may be, for example, control devices and/or types of control devices which are suitable for controlling the component. If the component and/or the component type is/are, for example, a servomotor and/or a particular type of servomotor, the compatibility indication may contain a list of control devices and/or types of control devices which are suitable for controlling the servomotor and/or a servomotor of a same type. If the component and/or the component type is/are a software component and/or a type of software component, the compatibility indication may contain a list of control devices and/or types of control devices which are able to execute the software component and/or a software component of a same type.

The module-type-specific calculation principles contained in the module type data or in the module data are now used, in particular, to calculate the requirements imposed on the performance features of the components of the drive system from the module-type-specific performance features. In the case of the exemplary “conveyor belt” module type, this means that the requirement imposed on the “motor power” performance feature of the “electric motor” component of the drive system is calculated on the basis of the “conveying capacity” performance feature of the module. The data processing device can then select a component type, the component-type-specific performance features of which meet the requirements imposed on the corresponding performance features of the component.

The selection process may be configured, in particular, in such a manner that a plurality of possible solutions are suggested to the user. The user can then choose from the plurality of suggested solutions. Alternatively and/or additionally, selected component types can be prioritized. The most suitable component types which are needed to implement the drive and appear to be most suitable on the basis of defined parameters are then suggested to the user, for example. These parameters which are used for prioritization can be included in the component type data. For example, the parameters may be costs of the components of the selected component types. This makes it possible to suggest the most cost-effective solution, for example.

In particular, if a plurality of component types are selected when selecting the at least one component type, the compatibility of the component types with one another can be taken into account in the selection process in such a manner that, if incompatibilities of individual component types with one another are detected, at least one component type is selected again. In this context, the method can provide for iterative loops to be run through until the compatibility of the selected component types with one another is ensured.

The method may provide for the user to be able to select a selected component type and to be able to have a display of alternative component types for selection. The method can then advantageously make it possible for the user to select one of the alternative component types instead of the originally selected component type. In particular, it is possible that the alternative component types must only be compatible with the module and/or the module type, that is to say compatibility of the alternative component types with other selected component types need not be absolutely necessary initially. In this case, after an alternative component type has been selected, the method may provide for the remaining originally selected component types to be selected again, for example in order to ensure that the compatibility of the other selected component types with the component type selected by the user is restored.

In practice, this may mean, for example, that four component types are selected for a module of the conveyor belt type. One component type relates to a type of electric motor, a further component type relates to a type of transmission and a further component type relates to a type of control device and the last component type relates to a type of software component. However, the user would like to select another type of transmission for design reasons. The user can then have a display of a selection of alternative types of transmissions which are compatible with the conveyor belt, for example by means of a suitable user input. In this case, it is possible that the type of transmission selected by the user is not compatible with the type of originally selected motor. In this case, a new selection method is carried out for at least the component type which relates to the type of motor. This new selected component type relating to the type of motor must now be compatible with the transmission selected by the user. Depending on the compatibility of the further originally selected component types with the component type selected by the user and/or the component type then newly selected for compatibility reasons, further renewed selections of component types may possibly be carried out until the four selected component types are compatible with one another again. The user then receives, as a selection, the transmission type manually selected by the user and compatible types of the motor, the control device and the software component.

The method may provide for the module type data to comprise a graphical representation of the respective module type. The graphical representation may be displayed to the user when selecting the module type. In particular, a plurality of graphical representations each representing the module types for selection can be displayed to the user. The representation can be displayed on a visualization device, for example a screen or a display. Alternatively and/or additionally, the selection can be made using “drag and drop”.

Within the framework of a multi-stage selection method, graphical representations representing particular groups of module types can also be displayed for selection. For example, the group of conveying devices can be represented by appropriate graphics, the selection of which then provides the individual module types belonging to the group for selection on the basis of assigned graphical representations of the group. It goes without saying that such a multi-stage selection may have any desired number of selection stages, wherein the module types are grouped in different grouping levels, for example in the manner of a tree structure. The selection can be made, in particular, by touching the graphical representation. In this case, the visualization device is preferably a touch-sensitive visualization device, for example a touch display. Alternatively and/or additionally, the selection can be made using a suitable pointing device, for example a computer mouse.

The method may provide for the user to be given the opportunity to process the module data after selecting the module type. For example, after selecting the “conveyor belt” module type, the user may be given the opportunity to adapt the “conveying capacity” performance feature. The module data relating to the affected module are accordingly changed.

As described above, the change in the module data may relate here to the performance features of the respective module, in particular. However, features relating to design properties of the affected module can also be adapted. For example, provision may be made for the user to be able to adapt the number of driven axles of the respective module.

In any case, it is advantageous if calculation principles stored in the module data can be adapted. In this manner, if the number of driven axles of a conveyor belt is changed for example, the calculation principle for the motor power required at the individual axles can be adapted on the basis of the conveying capacity of the conveyor belt.

Changing the module data relating to the module produces a new module type. Therefore, provision may be made for a new module type data object to be generated on the basis of the module data object of the module. This new module type data object can then be stored in the data storage device.

In this manner, it is possible to continuously further expand the data stock of predefined module types. This has the advantage for the provider of components for drive devices that customers can have their typical requirements imposed on the modules included in the module type data. In particular, when the customers' requirements with regard to the properties of the modules usually resemble one another or, in the best case scenario, are even identical, a type of “self-learning effect” occurs and results in module types which, with a higher degree of probability, correspond exactly or at least in an improved manner to the customers' requirements imposed on the respective module being predefined to the customers for selection.

In this context, it is possible, in particular, for the module data and/or the module type data to be linked to user accounts. This makes it possible to store an “intermediate status” when carrying out the method according to the system described herein. The method can be interrupted in this manner and continued at a later time. In this case, it can be ensured, in particular, that no unauthorized users gain access to the data stocks processed by a particular user.

In practice, this may mean, for example, that a customer receives a customer login, with which the customer logs onto a data processing device operated by a component provider. The data objects which are generated for this user by the data storage device can then contain an assignment to the respective user or user account.

This concerns, in particular, the module data objects and the component data objects. In principle, however, provision may also be made for module type data objects to be linked to a user account. It is then possible for users to be able to create and/or manage “their” module types on the basis of this assignment by processing the assigned module type data objects. In this context, it is conceivable for access to these module type data objects to be restricted and/or blocked for other users. In this case, access by the operator, in particular the provider of components, can nevertheless be enabled in order to evaluate the module type data objects processed by users and to therefore assist with market research activities, for example.

The module data objects and/or the component data objects may be assigned to projects or may contain links to project data objects. As described above for module data objects for example, the project data objects may be assigned to user accounts.

The assignment to projects makes it possible for the users to structure their work when using the described method. In particular, any technical device, for which the drive system is configured using the described method, can be assigned to a project.

This assignment makes it possible to easily find the technical device, in particular. The project data contained in the project data objects may contain, in particular, links to other data objects and may likewise contain data which have been adapted and/or can be adapted by the user, for example a project title.

Furthermore, the method can give the user the opportunity to predefine and/or process component data and/or component type data. This is advantageous, in particular, in a situation in which particular requirements arising from the sphere of the user are imposed on individual components of the drive system. For example, it may be the case that specifications relating to the components of the drive system exist on account of already existing planning and/or an already existing infrastructure.

These may be, for example, size restrictions for individual components. It is likewise possible that, on account of the limited performance of an energy supply system, the power consumption of a particular component, for example of an electric motor, must not exceed a particular value. In this case, the specifications made by the user for the component data of the drive system are taken into account when selecting the component types for the components of the drive system.

However, it is likewise also possible for components or at least one component to be predefined by the user before the data processing device selects the at least one component type for a component of the drive system.

This can be carried out, in particular, by virtue of the user himself selecting a component type for a component. This may be implemented, for example, by providing the user with access to component type data objects, with the result that the user selects the component type data object assigned to a suitable component type on the basis of the component type data stored in the component type data objects, whereupon a component data object assigned to the component of the drive system, the type of which has been selected, is generated on the basis of the corresponding component type data.

In practice, this would mean that the user selects, from a predefined range of component types, a component which in any case is intended to be part of the drive system.

This may be relevant in practice, in particular, when an already existing technical device is merely intended to be modernized. In this case, provision may be made for individual components of the drive system to be intended to be used further, for example motors and transmissions, whereas other components of the drive system are intended to be updated, for example a control device. In this case, the user would select the component types of the components which are intended to be obtained.

Alternatively and/or additionally, provision may be made for the user to have the opportunity to define and predefine components of the drive system. This may expediently be the case, for example, when components which are intended to be obtained are installed during the retrofitting of an already existing technical device, as already described above, wherein no corresponding component type data objects are assigned to these components.

This may be due, for example, to the fact that these components come from different manufacturers than the components which are intended to be configured using the described method. They may likewise be comparatively old components, for which there are no corresponding component type data objects on account of their age. The components defined by the user in this manner are accordingly taken into account during the selection of the at least one component by the data processing device.

The components can be predefined by the user by virtue of the data processing device generating a component data object assigned to the component, for example in response to a corresponding user input. The component data object contains component data which can be accordingly processed by the user.

The generation of the component data object may provide for recourse to be had to an existing component type data object, the data of which are then accordingly adapted by the user. In practice, this may mean that the user first of all selects a component type which comes close to the component to be predefined. For example, the user wishing to predefine a particular electric motor can select an electric motor type having similar properties.

The corresponding component data object is then generated, for example, from the component type data object assigned to this component type, and the user is given the opportunity to adapt the component data relating to this component data object to the properties of the component to be predefined. In practice, this may mean, for example, that the user, after having selected a motor type having properties similar to those of the motor type which is actually present, adapts the component data to the properties of the motor which is already present.

In a similar manner to the generation of new module types which has already been described above, new component types may likewise be defined for subsequent use, for example in other projects. This can be implemented, for example, by generating a component type data object on the basis of the component data object which has been created by the predefinition of a component by the user. This component type data object can be stored in the data storage device. In a similar manner to the above-described learning process on the module type level, the selection of available component types can also be continuously expanded on the component type level. Accordingly, assignments to user accounts can also be effected for the component type data objects, with the result that these self-defined component types are possibly protected from access by other users.

The component data and/or the component type data can be used to generate program code for programming a control device. In this context, the control device may be a component of the drive system.

Such control devices may undertake complex control tasks in a technical device and may control, in particular, a multiplicity of axles of a drive system, in particular also in a manner matched to one another. For this purpose, it is generally necessary to program the control device in a manner matched to the special features of the respective drive system or of the respective technical device. A corresponding program code for programming the control device can be generated—at least partially—in an automated manner by an accordingly programmed computer using corresponding information in the component data and/or the component type data.

This can be carried out within the scope of the described method by evaluating the module data, module type data, component data and/or component type data when generating the program code and generating the program code on the basis of the result of the evaluation. For example, regulating parameters which are provided in the program code can be calculated on the basis of component data and/or component type data. These regulating parameters are then written into the corresponding program code.

Alternatively and/or additionally, program code can be generated by providing and/or using component types which are selected using the present method and relate to software components. In this case, such software components can form the program code in the simplest case.

The software components may be, for example, in particular configurable, control programs or modules for such control programs. These control programs may be specific to particular categories of module types. A control program may be suitable, for example, for module types which are intended for pick-and-place applications.

It is also conceivable for the software components to be intended to supplement other software components. Such software components may be, for example, specific to particular kinematics which are used in particular module types or kinematically describe the latter, for example gantry kinematics, belt kinematics, kinematics of a delta robot and/or kinematics of a SCARA robot, possibly with a specific number of degrees of freedom. For example, a module type may relate to a SCARA robot which is intended to carry out pick-and-place applications. In this case, a first software component may be a control program which is specific to pick-and-place applications, and a second software component may be intended to supplement the first software component and may be specific to suitable kinematics for SCARA robots. Both software components make it possible to program a control device in such a manner that the drives of the SCARA robot can be controlled correctly in order to handle pick-and-place tasks using this robot.

Alternatively and/or additionally, software components can be used to implement drive-related basic operations. For example, a software component may be designed to enable continuous movements of a driven axle, to provide a virtual leading axis of a machine, to synchronize and/or couple drives with respect to position and/or speed, to monitor and/or regulate a temperature.

Alternatively and/or additionally, software components can also be used for complex drive-related control operations. Such software components may relate, for example, to the implementation of electrical cam disks, positioning profiles, for example for touch probe positioning, or the control of the movements of a technical device having a plurality of driven axles, for example a stacker crane.

In particular, the component data and/or component type data may contain predefined program code modules which are used when generating the program code. This is advantageous, in particular, when program code modules which are specific to the respective component or the respective component type are involved.

The modules, module types, components and/or component types may be assigned values for requirement units, which values quantitatively represent a requirement arising from a module and/or a component in the region of the control of the technical device or of the drive system. The module data, module type data, component data and/or component type data may comprise values of the requirement units.

The requirement units may relate to a quantitative power requirement with respect to the hardware of a control device, for example a processor speed, a processor time and/or a memory size. This configuration is based on the concept that modules of a particular type or components of a particular type give rise to a specific effort in terms of their control. This must be covered by a corresponding control device.

Depending on the complexity of a module for example, control devices having particular processor speeds and/or particular sizes of an internal memory may therefore be necessary in order to be able to control the corresponding module during its intended use. In this case, the requirement units can be used to select a sufficiently powerful control device by means of the data processing device.

For a practical example, this may mean that a value for requirement units, which relate to the main memory of a control device, is stored for a “conveyor belt” module type in the module type data. This may be, for example, an empirical value as regards how much memory is typically required in a control device for controlling a conveyor belt. The requirement units may then be a customary unit for indicating such memory spaces (for example gigabytes).

However, the requirement units may also relate to an amount of effort which arises when implementing the drive system. In particular, the requirement units may relate to programming effort, in particular when programming a control device of the drive system. Such requirement units can then also relate, in particular, to the costs of programming a control unit.

For a practical exemplary embodiment, this means that the values of a “programming costs” requirement unit, which are assigned to the respective module or to the respective component in their module data or component data, represent the costs which are caused by the respective module or the respective component when programming the control system.

The method may provide for the component data to be used to generate a component data list. The component data list may contain component data of all or a selection of components of the drive system. This makes it possible to create parts lists, for example. In particular, component data relating to the costs of the components may be included in the component data list. The component data lists make it possible to easily obtain an overview of the expected costs of the drive system.

In particular, the cost data lists may also comprise cost data which have been obtained on the basis of an evaluation of requirement units for programming effort, for example as described above for the control device. This makes it possible to obtain a comparatively precise cost estimate for the drive system of the planned technical device with comparatively little effort and already at a very early planning stage.

The method may provide for the user interface to be spatially remote from the data storage device, and for data to be interchanged between the data processing device and the data storage device and/or between the user interface and the data processing device via a remote data transmission device. The interchanged data may be, in particular, component data, component type data, module data and/or module type data.

In this case, “spatially remote” should be understood as meaning a distance which is so great that the user interface and the data storage device in any case must be parts of different individually usable technical devices. This may mean, for example, that the user interface and the data storage device are in different rooms, in different buildings and/or on different premises. The user interface and the data storage device may be parts of different computers, for example. The data storage device may be, for example, part of a server and the user interface may be part of a PC.

The remote data transmission device may be a wired remote data transmission device or a wireless remote data transmission device such as a WLAN. It is also possible for the data to be remotely transmitted via a plurality of remote data transmission devices of different types, for example for a PC to be incorporated, via a WLAN, in a wired intranet of a company, which is in turn connected, via a public remote data transmission network, to the wired intranet of a further company, which in turn operates the server.

The decision as regards which data are transmitted via the remote data transmission network is made, in particular, according to where the data processing takes place. According to the described method, it is possible, in principle, to allow the data processing to take place on a server, for example, which can also comprise the data storage device. This server can then provide, for example, a software interface which is based on a software protocol which can be processed using an Internet browser, for example. Such so-called web interfaces have the advantage that the user can access them without having to install special software on his computer for this purpose.

Alternatively, it is also possible to install a computer program on the user's computer, which computer program carries out the illustrated and described method. This computer program would then access the data stored in the data storage device via the remote data transmission device. Such a solution provides the advantage that the software interface, which is used to remotely access the data, is configured independently of the restrictions of software protocols which can be processed by conventional browsers. This can increase the speed and therefore the user-friendliness when carrying out the illustrated and described method.

In this context, it is also possible to store the data in a distributed manner. For example, component type data objects and module type data objects may be managed in a central data storage device, for example a data storage device operated by a component manufacturer, whereas the user locally stores the individual data objects assigned to his user account on his own data storage device.

Combining at least one data storage device, at least one data processing device and at least one user interface makes it possible to provide a configuration system for configuring a drive system, wherein the system is designed to carry out the method described and illustrated above.

In order to carry out the method described and illustrated above, the system may be configured by executing a computer program on a computer of the system, which computer program causes this computer to carry out the method described and illustrated above.

The features of the invention disclosed in the present description and in the claims may be essential to the implementation of the invention in its various embodiments both individually and in any desired combinations. The invention is not restricted to the embodiments described. It can be varied within the scope of the claims and taking into account the knowledge of the relevant person skilled in the art.

1. A method for configuring a drive system for a technical device composed of at least one module and the drive system is assembled from a plurality of components, comprising:
selecting the components of the drive system from a multiplicity of possible component types;
assigning each selectable component type a component type data object in a data storage device, wherein each component type data object includes component type data relating to properties of the component type;
a data storage device storing module type data objects which are assigned to module types, wherein module type data objects include module type data relating to properties of the module types; and
a user selecting a particular module type of the at least one module via a user interface, wherein, in response thereto, a data processing device generates a module data object which is assigned to the module and includes module data relating to the properties of the module type of the at least one module and selects the component type of at least one component of the drive system on the basis of the module data.

2. The method as claimed in claim 1, wherein the component types of the components of the drive system are selected on the basis of the component type data of the component type data objects assigned to the component types, and wherein component data objects assigned to the components are generated.

3. The method as claimed in claim 1, wherein the module data and/or the module type data relate to at least one module-type-specific performance feature, and wherein the performance feature is selected from:
a performance indication which relates to the performance of the module when performing a specific intended function of the module,
a compatibility indication which relates to compatibility of the module with another module and/or a component,
an indication of the number and/or respective function of driven axles.

4. The method as claimed in claim 1, wherein the component data and/or the component type data relate to at least one component-specific performance feature, and wherein the performance feature is selected from:
an indication relating to an intended function of the component as part of the drive system,
an indication relating to performance of a component during an intended use of the component, in particular an indication relating to a speed, a torque, a power,
a compatibility indication which relates to compatibility of the component with a module and/or another component.

5. The method as claimed in claim 1, wherein the module type data and/or the module data contain module-type-specific calculation principles for calculating technical requirements imposed on performance features of the components of the drive system.

6. The method as claimed in claim 5, wherein module-type-specific calculation principles include mechanical relationships between at least one axle driven by an electrical drive and an element of the module which is moved by the electric drive and is designed to interact with an object and/or mechanical relationships between an axle driven by the electrical drive and an object moved by the module by the drive.

7. The method as claimed in claim 1, wherein the user is given an opportunity to process the module data after selecting the module type to adapt values of technical properties contained in the module data, wherein a module type data object assigned to the module type newly created by processing of the module data is generated and stored.

8. The method as claimed in claim 1, wherein the user is given an opportunity to adapt and/or predefine components, component types, component data and/or component type data, wherein user adaptations and/or definitions are taken into account by the data processing device when selecting the component type of the at least one component.

9. The method as claimed in claim 1, wherein the component data and/or component type data are used to generate program code for a control device, wherein the component data and/or component type data contain predefined program code modules which are used when generating the program code.

10. The method as claimed in claim 1, wherein the modules, module types, components and/or component types are assigned values for a requirement unit, which values quantitatively represent a requirement arising from a module and/or a component in a region of a control of the technical device and/or of the drive system, wherein the module data, module type data, component data and/or component type data may include values of the requirement unit.

11. The method as claimed in claim 1, wherein the component data is used to generate a component data list containing component data relating to all or a selection of components of the drive system and to generate a component list for further processing in a goods management system, wherein the component data list includes component data relating to the costs of the components.

12. The method as claimed in claim 1, wherein the user interface is spatially remote from the data storage device, and data is interchanged between the data processing device and the data storage device and/or between the user interface and the data processing device via a remote data transmission device, wherein the data includes at least one data type selected from:
component data
component type data
module data
module type data.

13. A drive system, comprising:
at least one module; and
a plurality of components selected from a multiplicity of possible component types, wherein each selectable component type is assigned a component type data object in a data storage device, wherein each component type data object includes component type data relating to properties of the component type, wherein a data storage device stores module type data objects which are assigned to module types, module type data objects including module type data relating to properties of the module types, wherein a user selects a particular module type of the at least one module via a user interface, and wherein, in response thereto, a data processing device generates a module data object which is assigned to the module and includes module data relating to the properties of the module type of the at least one module and selects the component type of at least one component of the drive system on the basis of the module data.

14. A configuration system for configuring a drive system for a technical device, comprising:
a data storage device;
a data processing device; and
a user interface, wherein the system selects components of the drive system from a multiplicity of possible component types, assigns each selectable component type a component type data object in a data storage device, wherein each component type data object includes component type data relating to properties of the component type, a data storage device stores module type data objects which are assigned to module types, wherein module type data objects include module type data relating to properties of the module types, and a user selects a particular module type of the at least one module via a user interface, wherein, in response thereto, a data processing device generates a module data object which is assigned to the module and includes module data relating to the properties of the module type of the at least one module and selects the component type of at least one component of the drive system on the basis of the module data.

15. A computer program comprising instructions which, during execution of the program by a computer, cause the computer to select the components of a drive system from a multiplicity of possible component types, assign each selectable component type a component type data object in a data storage device, wherein each component type data object includes component type data relating to properties of the component type, wherein a data storage device stores module type data objects which are assigned to module types, wherein module type data objects include module type data relating to the properties of the module types, and wherein a user selects a particular module type of the at least one module via a user interface, wherein, in response thereto, a data processing device generates a module data object which is assigned to the module and includes module data relating to the properties of the module type of the at least one module and selects the component type of at least one component of the drive system on the basis of the module data.
